(19) United States
(12) Patent Application Publication
(10) Pub. No.: US 2024/0157508 A1
(43) Pub. Date: May 16, 2024

(54) ELECTRIC TOOL GRINDING MACHINE AND GRINDING DISC COVER THEREOF

(71) Applicant: X'POLE PRECISION TOOLS INC., Taoyuan City (TW)

(72) Inventor: Bach Pangho CHEN, Claremont, CA (US)

(21) Appl. No.: 17/984,629

(22) Filed: Nov. 10, 2022

(51) Int. Cl. B24B 47/26; B24B 23/02; B24B 47/12; H02K 7/14; H02K 9/06

(52) U.S. Cl. CPC B24B 47/26; B24B 23/02; B24B 47/12; H02K 7/145; H02K 9/06

(57) ABSTRACT

An electric tool grinding machine and a grinding disc cover thereof, the machine includes a grip body, an electric motor, a grinding disc, and an airflow generating member. When the motor rotates, the member forms a heat dissipation airflow in the grip body. The grinding disc cover is assembled with the grip body and covers the member therein. The grinding disc cover includes a cover body, an assembly port, and a release port facing the grinding disc, the cover body does not have a vent hole other than the assembly and release ports, when the release port is viewed from the assembly port toward the release port, an inner wall of the release port has a flow guiding section, an air outlet section with a slope different from that of the flow guiding section, and an arcuate diversion section connecting between the flow guiding and air outlet sections.

### FIELD OF THE INVENTION

The invention relates to an electric tool grinding machine, particularly to an electric tool grinding machine with a grinding disc cover capable of guiding airflow outlet direction, and the grinding disc cover is without lateral vent hole.

### BACKGROUND OF THE INVENTION

An existing electric tool grinding machine is generally attached with an airflow generating member to an eccentric block to which the tool grinding machine belongs, so as to generate heat dissipation airflow through the airflow generating member, and discharge waste heat generated by the electric tool grinding machine during operation. One such embodiment is as provided in European Patent No. EP2132000B1, or as depicted in FIG. 1. In the technical solution shown in FIG. 1, a grinding disc cover 61 of an electric tool grinding machine 60 is provided with vent holes 611 arranged at intervals in a lateral direction, an airflow generating member 62 is disposed close to the vent holes 611, and at the same time close to a port of the grinding disc cover 61 connected to a grip body 63. Ideally, when the airflow generating member 62 rotates, the airflow generating member 62 introduces air through the vent holes 611 for heat dissipation. However, because the vent holes 611 are spaced apart from one another and the airflow generating member 62 is too close to the vent holes 611, the vent holes 611 cannot produce the expected effect in practice. When one of the vent holes 611 intakes air, an adjacent one of the vent holes 611 discharges air, resulting in a short flow problem (also known as short cycle), as shown in FIG. 2. As a result, air intake of the vent holes 611 is not as efficient as expected, and the short flow problem further causes the heat dissipation effect of the airflow generating member 62 to be limited on the eccentric block. Although waste heat can be exhausted as the eccentric block is connected to an electric motor 64, a diameter of a shaft of the eccentric block connecting with the electric motor 64 is generally small, and the waste heat transfer speed is not as fast as the speed of heat generated by the electric motor 64 itself, resulting in continuous accumulation of waste heat, which affects the user's feeling when holding and using the electric tool grinding machine 60.

Furthermore, although some embodiments are implemented with a plurality of air inlet holes 631 on the grip body 63, the outside air is sucked in through the plurality of air inlet holes 631 by rotation of the airflow generating member 62 to form a heat dissipation airflow. Based on the aforementioned structures, it can be known that the airflow generating member 62 has the problem of poor air intake efficiency and cannot generate suction that meets the requirements. As a result, air volume of the heat dissipation airflow is insufficient to effectively dissipate heat from the electric motor 64, and therefore the problem of waste heat accumulation of the electric motor 64 is still serious. In addition, the above-mentioned structure is originally expected to enhance heat exchange with the electric motor 64 through a large air volume, but the conventional solution does not take fluid mechanics of the grinding disc cover 61 into consideration, which arranges the grinding disc cover 61 only to provide the function of shielding a grinding disc 65. An inner wall of the existing grinding disc cover 61 is an inclined surface, and an end of the inclined surface faces the grinding disc 65. The above-mentioned design will cause the heat dissipation airflow to be discharged directly to the grinding disc 65, the heat dissipation airflow impacting the grinding disc 65 will cause turbulence in the grinding disc cover 61, turbulence will affect the exhaust air, and results in failure in achieving the originally expected large air volume.

Currently, the only solution that can solve the aforementioned problems is to implement an active dust suction structure 71 on an electric tool grinding machine 70, as shown in FIG. 3 or European Patent No. EP2946710B1. As shown in FIG. 3, an air inlet of the active dust suction structure 71 is a suction port 721 formed on a grinding disc cover 72. During implementation, the active dust suction structure 71 generates suction in a space in the grinding disc cover 72, the aforementioned suction is obviously greater than the suction generated by an airflow generating member 73, and also a large amount of air sucked in through a plurality of air inlets 741 on a grip body 74 contributes greatly to heat dissipation of an electric motor 75.

However, not all electric tool grinding machines can be equipped with the active dust suction structure, and therefore there is still a need for a solution to solve heat accumulation of the electric motor when the electric tool grinding machine is not equipped with the active dust suction structure.

### SUMMARY OF THE INVENTION

A main object of the invention is to solve the consequence of the conventional grinding disc cover on a heat dissipation airflow.

A secondary object of the invention is to solve the problem that heat accumulated in an electric motor of the conventional electric tool grinding machine cannot be easily discharged.

In order to achieve the above objects, the invention provides an electric tool grinding machine including a grip body, an electric motor, an eccentric block, a grinding disc, an airflow generating member, and a grinding disc cover. The grip body is formed with at least one air intake hole. The electric motor is disposed in the grip body. The eccentric block is connected to the electric motor and rotates with the electric motor. The grinding disc is assembled with the eccentric block. The airflow generating member is attached on the eccentric block. When the electric motor rotates, the airflow generating member forms a heat dissipation airflow in the grip body. The grinding disc cover is assembled with the grip body and covers the airflow generating member therein. The grinding disc cover includes a cover body, an assembly port formed at an end of the cover body and assembled with the grip body, and a release port formed at an other end of the cover body and facing the grinding disc. The cover body is devoid of a vent hole other than the assembly port and the release port. The release port is the only exhaust part of the grinding disc cover. When the release port is viewed from a direction of the assembly port toward the release port, an inner wall of the release port sequentially includes a flow guiding section, an arcuate diversion section, and an air outlet section with a slope different from a slope of the flow guiding section. The arcuate diversion section divertes an airflow direction of the heat dissipation airflow discharged between the grinding disc cover and the grinding disc to be parallel to the grinding disc.

In one embodiment, the airflow generating member includes a baseplate and a plurality of fan blades separated provided on the baseplate, a distance defined between a top edge of each of the plurality of fan blades and the grip body is greater than 50% of a longitudinal length of each of the plurality of fan blades, and a distance defined between an outer edge of each of the plurality of fan blades and the grinding disc cover is greater than 50% of a radial length of each of the plurality of fan blades.

In one embodiment, a horizontal level of the release port is equal to or lower than a horizontal level of the baseplate inside the grinding disc cover.

In one embodiment, a distance defined between the release port and each of the plurality of fan blades is greater than a radial length of each of the plurality of fan blades.

In one embodiment, the cover body includes an inclined surface between the assembly port and the release port, the inclined surface is connected with the flow guiding section of the release port, and a slope of the flow guiding section is same as a slope of the inclined surface.

In one embodiment, a horizontal level of a top end of the inclined surface is same as or higher than a horizontal level of each of the plurality of fan blades.

In addition to the foregoing, the invention further provides a grinding disc cover of an electric tool grinding machine including a cover body, an assembly port formed at an end of the cover body, and a release port formed at an other end of the cover body and coaxially disposed with the assembly port. A diameter of the release port is greater than a diameter of the assembly port, when the release port being viewed from a direction of the assembly port toward the release port, an inner wall of the release port sequentially includes a flow guiding section, an arcuate diversion section, and an air outlet section with a slope different from a slope of the flow guiding section. The cover body is devoid of a vent hole other than the assembly port and the release port.

In one embodiment, the cover body includes an inclined surface between the assembly port and the release port, the inclined surface is connected with the flow guiding section of the release port, and a slope of the flow guiding section is same as a slope of the inclined surface.

In one embodiment, the cover body includes an engaging ring formed around the assembly port, and a continuous concave-convex structure is formed on an inner side of the engaging ring.

Through the aforementioned implementation of the invention, compared with the conventional technique, the invention has the following features: the grinding disc cover of the invention has an attached effect (also known as the Coandă effect) on an inner wall of the release port, so that the heat dissipation airflow is not discharged directly toward the grinding disc to avoid turbulence and to make the heat dissipation airflow to flow smoothly. Further, due to smooth discharge of the heat dissipation airflow, the heat dissipation airflow generated in the electric tool grinding machine is increased, which solves the problem that it is not easy to dissipate heat from the electric motor of the conventional electric tool grinding machine.

### BRIEF DESCRIPTION OF THE DRAWINGS

FIG. 1 is a first schematic diagram of implementation of a conventional electric tool grinding machine.

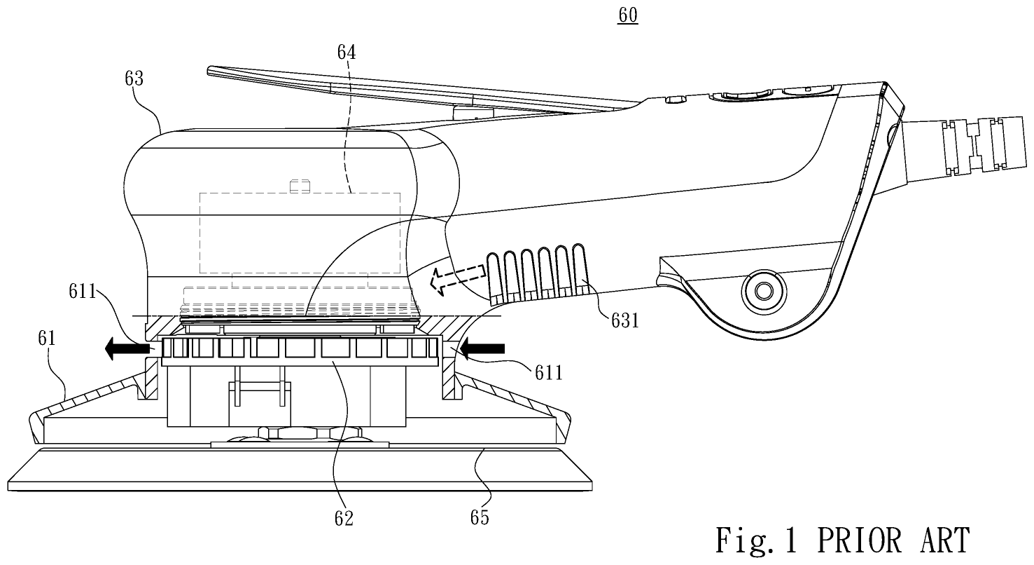

FIG. 2 is a schematic diagram of wind flow of a conventional grinding disc cover.

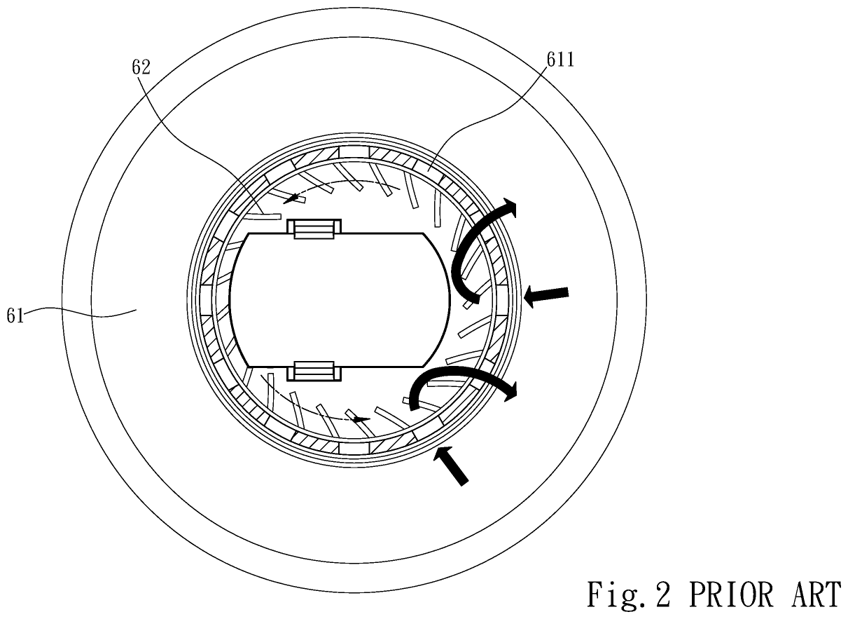

FIG. 3 is a second schematic diagram of implementation of the conventional electric tool grinding machine.

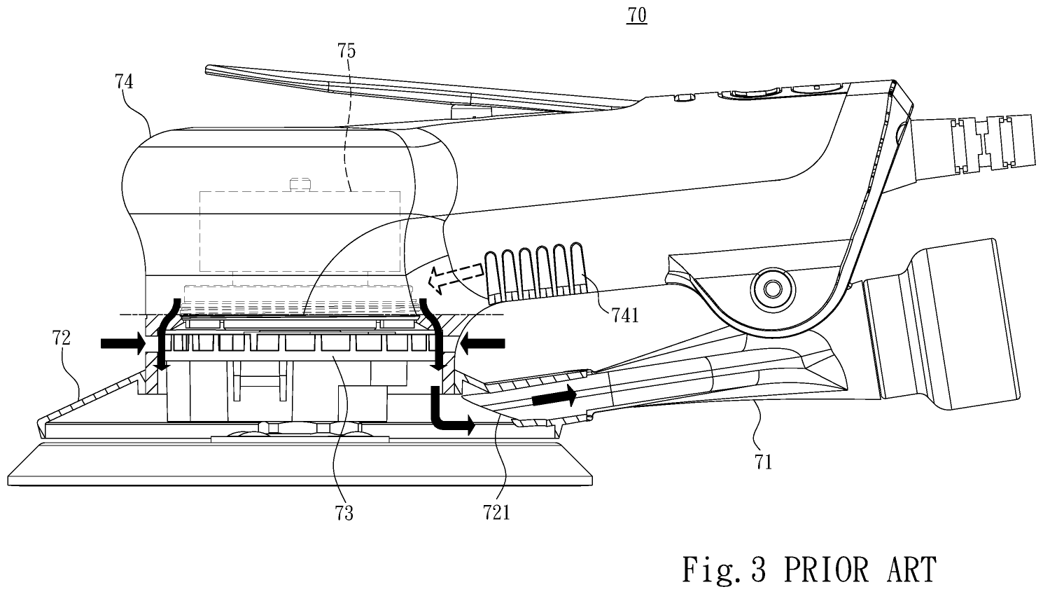

FIG. 4 is a perspective view of an electric tool grinding machine of the invention.

FIG. 5 is a perspective exploded view of structures of the electric tool grinding machine of the invention.

FIG. 6 is a cross-sectional structural view of the electric tool grinding machine of the invention.

FIG. 7 is a top view of partial structures of the electric tool grinding machine of the invention.

FIG. 8 is a first cross-sectional view of partial structures of the electric tool grinding machine of the invention.

FIG. 9 is a second cross-sectional view of partial structures of the electric tool grinding machine of the invention.

FIG. 10 is a first path diagram of a heat dissipation airflow of the electric tool grinding machine of the invention.

FIG. 11 is a second path diagram of the heat dissipation airflow of the electric tool grinding machine of the invention.

FIG. 12 is a third path diagram of the heat dissipation airflow of the electric tool grinding machine of the invention.

### DETAILED DESCRIPTION OF THE PREFERRED EMBODIMENTS

The detailed description and technical content of the invention are described below with reference to the accompanying drawings.

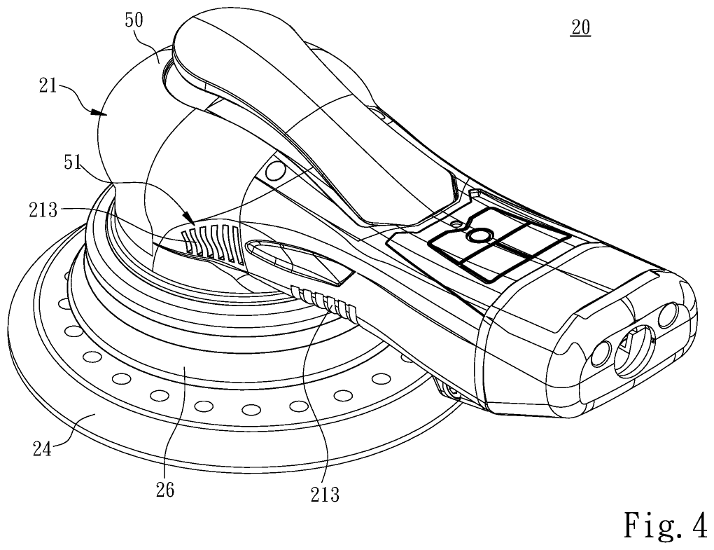

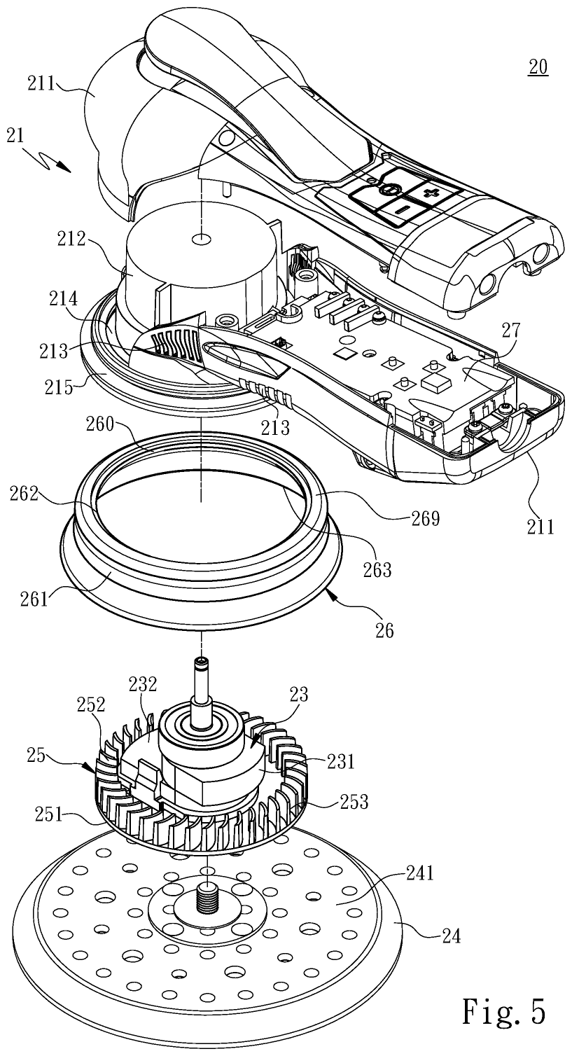

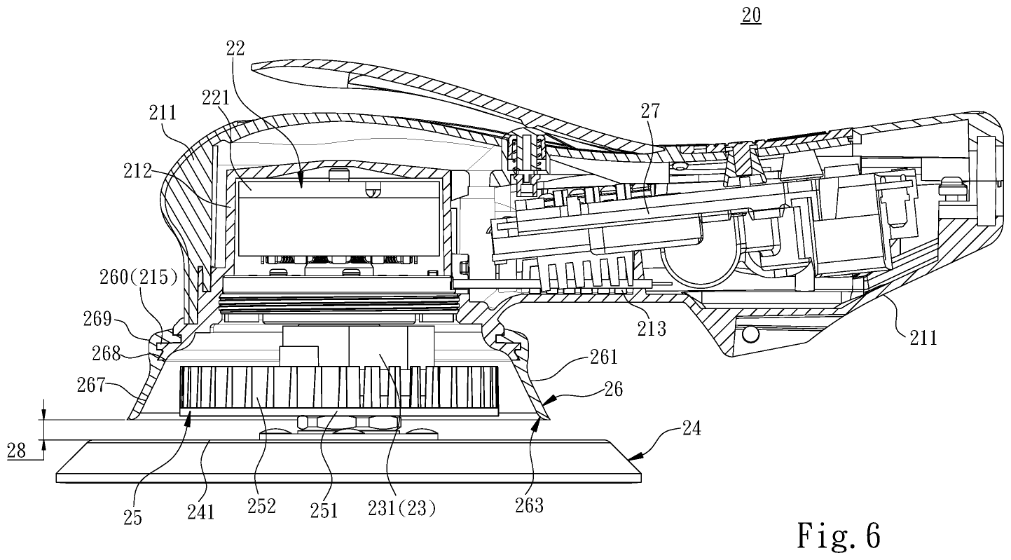

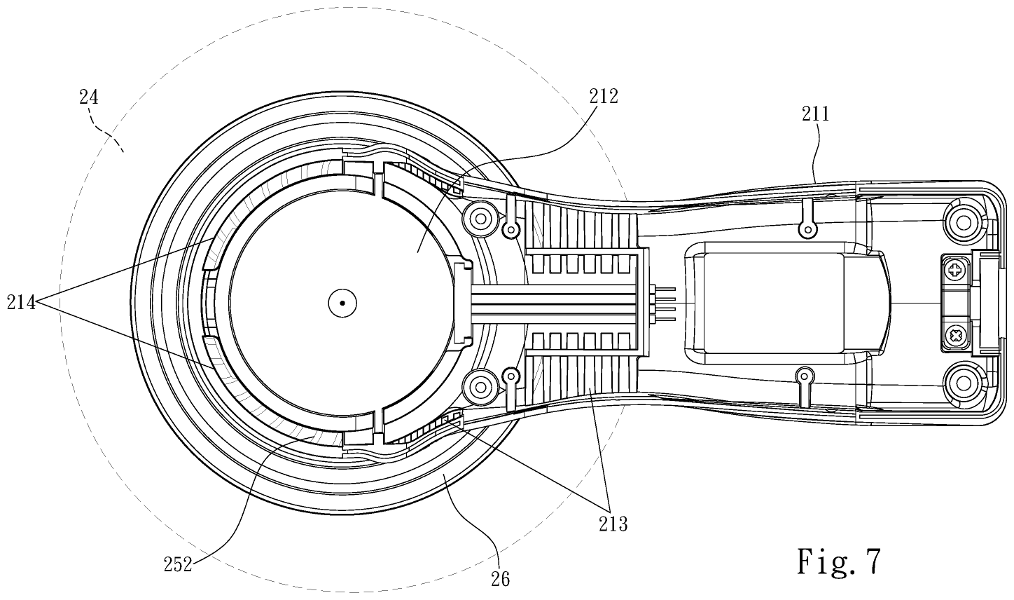

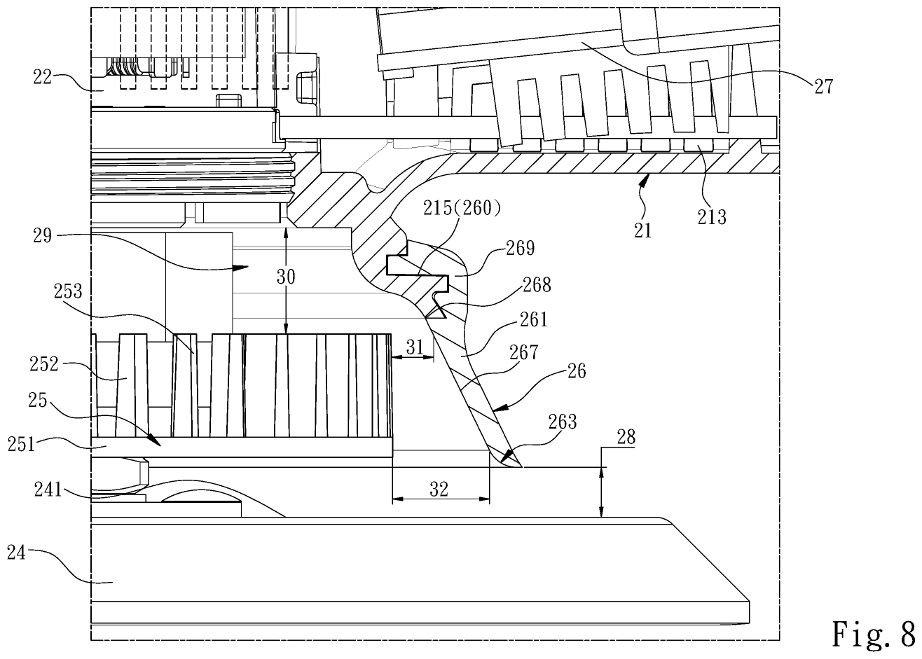

Please refer to FIG. 4, FIG. 5, FIG. 6, FIG. 7, and FIG. 8, the invention provides an electric tool grinding machine 20 including a grip body 21, an electric motor 22, an eccentric block 23, a grinding disc 24, an airflow generating member 25 and a grinding disc cover 26. The grip body 21 can be formed by connecting a plurality of shells 211. In addition to providing the electric motor 22 to dispose in an inner space of the grip body 21, a control circuit board 27 for controlling operation of the electric motor 22 is also disposed in the inner space of the grip body 21. One of the plurality of shells 211 is provided with a motor housing 212 capable of covering the electric motor 22 therein. In addition, the grip body 21 is provided with a plurality of air intake holes 213, the plurality of air intake holes 213 are respectively opened on an outer surface of part of the grip body 21 corresponding to the control circuit board 27, and an outer surface of the grip body 21 providing a part where a user's fingers grasp. In one embodiment, the grip body 21 includes at least one air hole 214 that communicates with an inside of the grip body 21 and the grinding disc cover 26. The at least one air hole 214 is formed on one of the plurality of shells 211 which is provided with the motor housing 212, and the at least one air hole 214 is disposed along an edge of the motor housing 212. Further, the air hole 214 is arcuate.

Furthermore, the electric motor 22 can be an internal rotor motor or an external rotor motor. The eccentric block 23 is connected to a rotor 221 of the electric motor 22 and rotates with the rotor 221. In one embodiment, the eccentric block 23 comprises a first part 231 connected to the electric motor 22, and a second part 232 connected to the first part 231. A center of the second part 232 offsets from a center of the first part 231. The grinding disc 24 is assembled on the eccentric block 23. An air exhaust area 28 is defined between the grinding disc 24 and an edge of the grinding disc cover 26.

Please refer to FIG. 5, the airflow generating member 25 is attached on the eccentric block 23 and located in a space defined by the grinding disc cover 26. The airflow generating member 25 and the eccentric block 23 rotate together. The airflow generating member 25 comprises a baseplate 251 and a plurality of fan blades 252 disposed on the baseplate 251. The plurality of fan blades 252 are of a same shape, and the plurality of fan blades 252 are only disposed on a side of the baseplate 251 facing the eccentric block 23, the plurality of fan blades 252 are separately disposed and arranged in a circle on the baseplate 251. In order to smoothly introduce a large amount of air into the grip body 21, the airflow generating member 25 of the invention is disposed in the space defined by the grinding disc cover 26 based on the following conditions: a distance (as indicated by 30 in FIG. 8) defined between a top edge of each of the plurality of fan blades 252 and the grip body 21 is greater than 50% of a longitudinal length of each of the plurality of fan blades 252, a distance (as indicated by 31 in FIG. 8) defined between an outer edge of each of the plurality of fan blades 252 and the grinding disc cover 26 is greater than 50% of a radial width of each of the plurality of fan blades 252, and an outer radius of the airflow generating member 25 is greater than a distance from the air hole 214 to a center of the motor housing 212. Based on the aforementioned conditions, the airflow generating member 25 is not in close contact with the grip body 21 and the grinding disc cover 26, but is capable of generating an airflow temporary storage area 29, and the airflow temporary storage area 29 is capable of keeping a wind guiding effect of the airflow generating member 25 smooth.

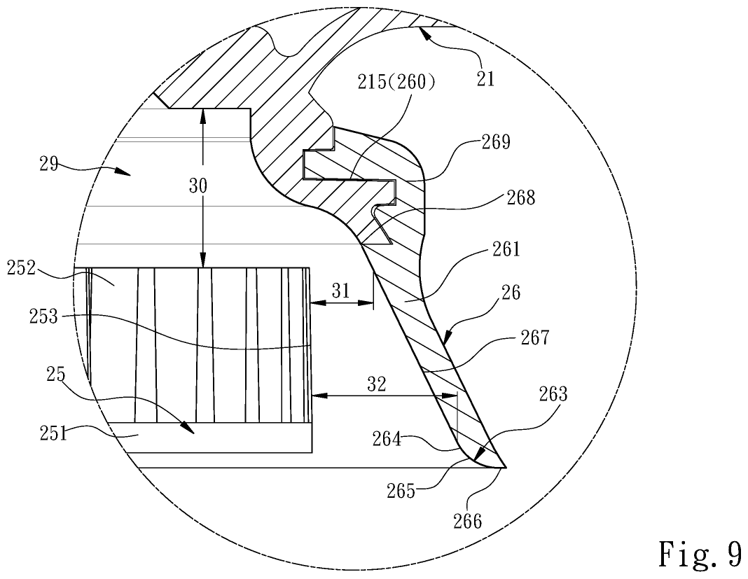

Please refer to FIG. 5, FIG. 6 and FIG. 8, the grinding disc cover 26 is assembled with the grip body 21, and the airflow generating member 25 is being covered in the grinding disc cover 26. The grinding disc cover 26 comprises a cover body 261, an assembly port 262 formed at one end of the cover body 261, and a release port 263 formed at an other end of the cover body 261. The grinding disc cover 26 of the invention does not have a vent hole other than the assembly port 262 and the release port 263. The assembly port 262 is coaxially disposed with the release port 263, that is, the assembly port 262 and the release port 263 are disposed correspondingly to each other. Please refer to FIG. 9, the release port 263 is the only exhaust part of the grinding disc cover 26. When the release port 263 is viewed from a direction of the assembly port 262 toward the release port 263, an inner wall of the release port 263 sequentially includes a flow guiding section 264, an arcuate diversion section 265, and an air outlet section 266. The flow guiding section 264 is connected with an inner wall surface of the cover body 261 close to the release port 263 without discontinuity and without difference in level. The flow guiding section 264 forms a flat surface together with the inner wall surface of the cover body 261 close to the release port 263. The arcuate diversion section 265 serves as a connection between the flow guiding section 264 and the air outlet section 266. The air outlet section 266 and the flow guiding section 264 have different slopes. Further, an included angle between the air outlet section 266 and the flow guiding section 264 is greater than 90 degrees. Furthermore, the air outlet section 266 can be parallel to a surface 241 of the grinding disc 24 facing the grinding disc cover 26.

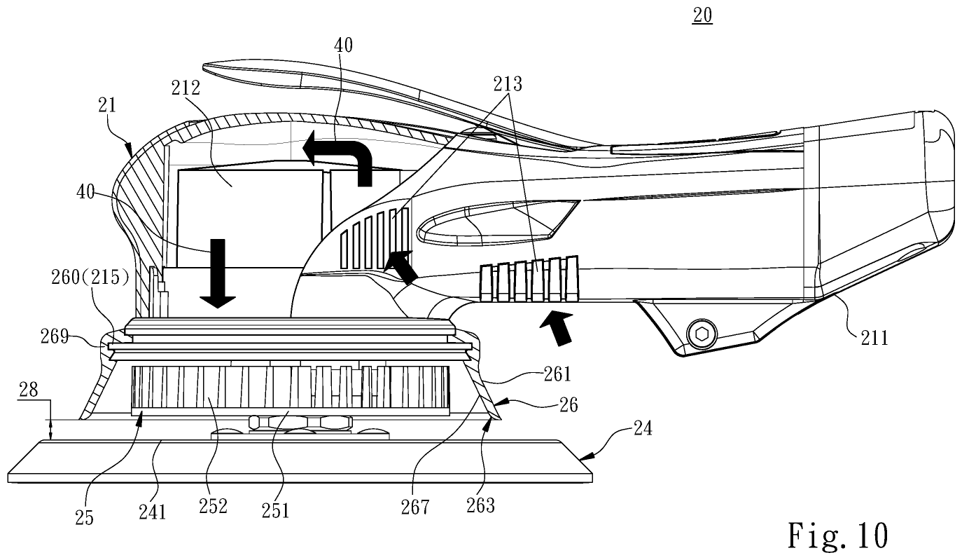

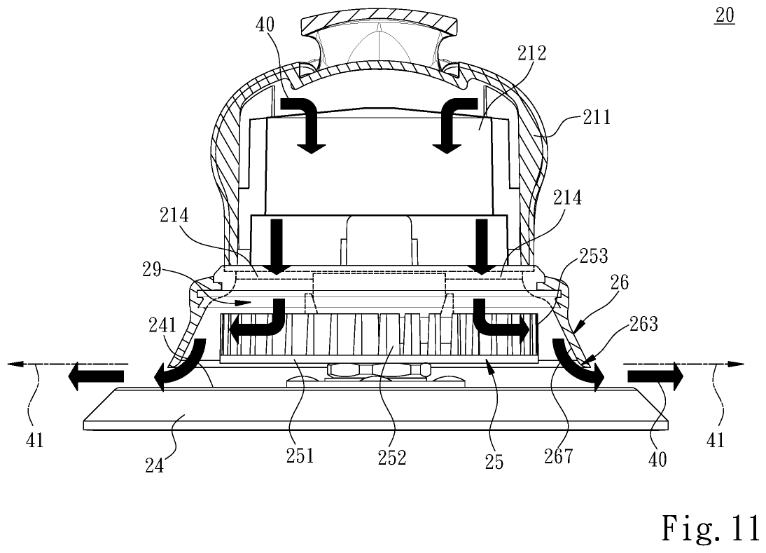

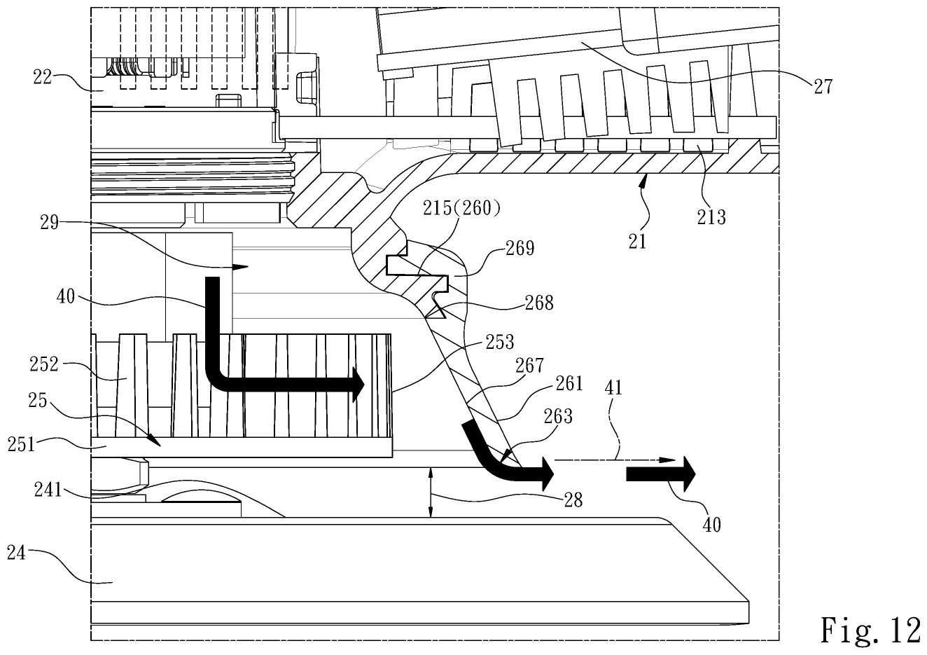

Please refer to FIG. 10, FIG. 11 and FIG. 12. When the airflow generating member 25 rotates, a heat dissipation airflow 40 is formed in the electric tool grinding machine 20. Specifically, the heat dissipation airflow 40 enters the grip body 21 through the plurality of air intake holes 213, travels through the motor housing 212, passes through the air hole 214, the airflow temporary storage area 29 and the airflow generating member 25 in sequence, and is finally discharged from the air exhaust area 28. When the heat dissipation airflow 40 passes through the release port 263, a wall surface of the release port 263 (i.e., the flow guiding section 264, the arcuate diversion section 265, and the air outlet section 266) will produce an attached effect (also known as the Coandă effect), the heat dissipation airflow 40 is affected by the arcuate diversion section 265 to change a flow direction, and is finally discharged from the air exhaust area 28 according to a shape of the air outlet section 266. Specifically, the arcuate diversion section 265 diverts an airflow direction 41 of the heat dissipation airflow 40 to be parallel to the grinding disc 24 when discharging between the grinding disc cover 26 and the grinding disc 24. Accordingly, in the invention, through a guiding structure on the release port 263, the heat dissipation airflow 40 is not discharged directly toward the grinding disc 24, so as to prevent the heat dissipation airflow 40 from directly impacting the grinding disc 24 and generating turbulence in the air exhaust area 28, which affects an overall efficiency of the heat dissipation airflow 40. That is to say, the release port 263 of the invention guides the heat dissipation airflow 40 to discharge smoothly through the Coandă effect.

Based on the above, the invention is still capable of generating the heat dissipation airflow 40 that meets heat dissipation requirements of the electric motor 22 through cooperation of the grinding disc cover 26 and the airflow generating member 25 when the electric tool grinding machine 20 is not installed with an active dust suction structure. The invention also improves the problem that heat accumulated in the electric motor 22 cannot be easily discharged and increases the comfort of the user's palm during long holding and use. Please refer to Table 1 and Table 2. Table 1 is a comparison table of temperature rise between the invention and the conventional technique. Specifically, “the invention” refers to the electric tool grinding machine 20 of the invention, “convention without suction” refers to a conventional electric tool grinding machine not equipped with an active dust suction structure and equipped with a grinding disc cover with vent holes, and “convention with suction” refers to a conventional electric tool grinding machine equipped with an active dust suction structure. A temperature measurement point of Table 1 (indicated as 50 in FIG. 4) is the palm position when the user is grasping the electric tool grinding machine, and the electric tool grinding machine is provided with 80 grit abrasive paper (#80) and 6 inches overall diameter grinding disc and is at a load of 180 watts (W). Basic conditions of Table 2 are the same as those of Table 1, the only difference is that the temperature measurement point of Table 2 is the user's finger grip position (indicated as 51 in FIG. 4).

TABLE 1

| | | Machine running time | | | | |
|---|---|---|---|---|---|---|
| | Ambient | 10 | 15 | 20 | 25 | 30 |
| | temperature | minutes | minutes | minutes | minutes | minutes |
| The invention | 22.3 | 28.8 | 30.9 | 31.7 | 31.8 | 31.7 |
| Convention | 22.8 | 37.4 | 43.3 | 48.1 | 51.9 | 53.1 |
| without suction | | | | | | |
| Convention | 21.8 | 31.9 | 31.4 | 32.3 | 31.0 | 32.0 |
| with suction | | | | | | |

TABLE 2

| | | Machine running time | | | | |
|---|---|---|---|---|---|---|
| | Ambient | 10 | 15 | 20 | 25 | 30 |
| | temperature | minutes | minutes | minutes | minutes | minutes |
| The invention | 22.3 | 24.8 | 25.2 | 24.9 | 24.4 | 24.3 |
| Convention | 22.8 | 45.1 | 51.8 | 54.7 | 62.3 | 61.1 |
| without suction | | | | | | |
| Convention | 21.8 | 27.9 | 28.9 | 28.1 | 29.2 | 28.9 |
| with suction | | | | | | |

As indicated in Table 1 and Table 2, it can be understood unambiguously that when the conventional technique without dust suction continues to operate for 15 minutes, the temperatures of the palm measurement point and the finger grip measurement point increase significantly. With the high temperatures at the palm measurement point and the finger grip measurement point located on a surface of the electric tool grinding machine, it can be speculated that a temperature caused by waste heat accumulation of electric motor inside electric tool grinding machine will be higher, which highlights that the heat dissipation airflow generated by the conventional technique is incapable of effectively dissipating accumulated heat of the electric motor, and the structure of the grinding disc cover significantly affects an efficiency of the heat dissipation airflow. Comparing the temperatures of the invention and the conventional technique with dust suction during the different operation times of the electric tool grinding machine, in addition to the temperatures of the palm measurement point of the invention without the active dust suction structure are on par with the temperatures of the conventional technique with dust suction, performance of the invention without the active dust suction structure produced at the finger grip measurement point (Table 2) is significantly better than that of the conventional technique with dust suction. Accordingly, structure of the release port 263 of the grinding disc cover 26 of the invention significantly affects efficiency of the heat dissipation airflow 40. The heat dissipation airflow 40 practically meets heat dissipation requirements of the electric motor 22. The invention improves the problem of heat accumulation of the electric motor that the conventional technique is incapable of solving.

Please refer to FIG. 8. In one embodiment, a horizontal level of the release port 263 is equal to or lower than a horizontal level of the baseplate 251 of the airflow generating member 25 in the grinding disc cover 26 in order to effectively guide the heat dissipation airflow 40.

Please refer to FIG. 5, FIG. 6, FIG. 7, and FIG. 8, a diameter of the release port 263 is greater than a diameter of the assembly port 262. The grinding disc cover 26 is trumpet-shaped. A flow velocity of the heat dissipation airflow 40 entering the grinding disc cover 26 from the air hole 214 is slowed down in order to prevent a flow velocity of the heat dissipation airflow 40 from being too fast to generate turbulence in the grinding disc cover 26. In one embodiment, a distance (as indicated by 32 in the figure) between the release port 263 and each of the plurality of fan blades 252 is greater than a radial length of each of the plurality of fan blades 252. In addition, the cover body 261 includes an inclined surface 267 between the assembly port 262 and the release port 263, the inclined surface 267 is connected with the flow guiding section 264 of the release port 263, and a slope of the flow guiding section 264 is same as a slope of the inclined surface 267. Further, there is no level difference between the flow guiding section 264 and the inclined surface 267. Furthermore, a horizontal level of a top end 268 of the inclined surface 267 is same as or higher than a horizontal level of each of the plurality of fan blades 252. The top end 268 of the inclined surface 267 faces a top end of each of the plurality of fan blades 252, and the release port 263 faces a bottom end of each of the plurality of fan blades 252. The heat dissipation airflow 40 exhausted from an air outlet end 253 of each of the plurality of fan blades 252 is effectively guided.

Please refer to FIG. 6 and FIG. 8. In one embodiment, the cover body 261 includes an engaging ring 269 formed around the assembly port 262, and a continuous concave-convex structure 260 is formed on an inner side of the engaging ring 269. The grip body 21 includes a connecting concave-convex structure 215 assembled with the continuous concave-convex structure 260 at a position where the assembly port 262 is assembled.

What is claimed is:

1. An electric tool grinding machine, comprising:
a grip body, formed with at least one air intake hole;
an electric motor, disposed in the grip body;
an eccentric block, connected to the electric motor and rotating with the electric motor;
a grinding disc, assembled with the eccentric block;
an airflow generating member, attached on the eccentric block, and when the electric motor rotating, the airflow generating member forming a heat dissipation airflow in the grip body; and
a grinding disc cover, assembled with the grip body and covering the airflow generating member therein, the grinding disc cover comprising a cover body, an assembly port formed at an end of the cover body and assembled with the grip body, and a release port formed at an other end of the cover body and facing the grinding disc, the cover body being devoid of a vent hole other than the assembly port and the release port, the release port being the only exhaust part of the grinding disc cover, when the release port being viewed from a direction of the assembly port toward the release port, an inner wall of the release port sequentially comprising a flow guiding section, an arcuate diversion section, and an air outlet section with a slope different from a slope of the flow guiding section, and the arcuate diversion section diverting an airflow direction of the heat dissipation airflow discharging between the grinding disc cover and the grinding disc to be parallel to the grinding disc.

2. The electric tool grinding machine as claimed in claim 1, wherein the airflow generating member comprises a baseplate and a plurality of fan blades separately provided on the baseplate, a distance defined between a top edge of each of the plurality of fan blades and the grip body is greater than 50% of a longitudinal length of each of the plurality of fan blades, and a distance defined between an outer edge of each of the plurality of fan blades and the grinding disc cover is greater than 50% of a radial length of each of the plurality of fan blades.

3. The electric tool grinding machine as claimed in claim 2, wherein a horizontal level of the release port is equal to or lower than a horizontal level of the baseplate inside the grinding disc cover.

4. The electric tool grinding machine as claimed in claim 2, wherein a distance defined between the release port and each of the plurality of fan blades is greater than a radial length of each of the plurality of fan blades.

5. The electric tool grinding machine as claimed in claim 4, wherein the cover body comprises an inclined surface between the assembly port and the release port, the inclined surface is connected with the flow guiding section of the release port, and a slope of the flow guiding section is same as a slope of the inclined surface.

6. The electric tool grinding machine as claimed in claim 5, wherein a horizontal level of a top end of the inclined surface is same as or higher than a horizontal level of each of the plurality of fan blades.

7. A grinding disc cover of an electric tool grinding machine comprising:
a cover body;
an assembly port, formed at an end of the cover body; and
a release port, formed at an other end of the cover body and coaxially disposed with the assembly port, a diameter of the release port being greater than a diameter of the assembly port, when the release port being viewed from a direction of the assembly port toward the release port, an inner wall of the release port sequentially comprising a flow guiding section, an arcuate diversion section, and an air outlet section with a slope different from a slope of the flow guiding section;
wherein the cover body is devoid of a vent hole other than the assembly port and the release port.

8. The grinding disc cover of the electric tool grinding machine as claimed in claim 7, wherein the cover body comprises an inclined surface between the assembly port and the release port, the inclined surface is connected with the flow guiding section of the release port, and a slope of the flow guiding section is same as a slope of the inclined surface.

9. The grinding disc cover of the electric tool grinding machine as claimed in claim 7, wherein the cover body comprises an engaging ring formed around the assembly port, and a continuous concave-convex structure is formed on an inner side of the engaging ring.
